(19) United States
(12) Patent Application Publication
(10) Pub. No.: US 2017/0259558 A1
(43) Pub. Date: Sep. 14, 2017

(54) METHOD FOR MANUFACTURING REPRODUCTION OF PAINTING

(71) Applicant: TOKUYAMA CORPORATION, Shunan-shi, Yamaguchi (JP)

(72) Inventor: Koki HIRAYAMA, Shunan-shi (JP)

(73) Assignee: TOKUYAMA CORPORATION, Shunan-shi, Yamaguchi (JP)

(21) Appl. No.: 15/509,804

(22) PCT Filed: Sep. 8, 2015
(86) PCT No.: PCT/JP2015/075506

§ 371 Date: Mar. 8, 2017

(30) Foreign Application Priority Data
Sep. 9, 2014 (JP) 2014-182974

(51) Int. Cl. B41J 2/01; B41M 5/52

(52) U.S. Cl. CPC B41J 2/01; B41M 5/5227

(57) ABSTRACT

An object of the present invention is to provide a method for manufacturing a reproduction of a painting, which can use different types of paintings as original paintings and reproduce the matiere of the original painting and which also improves the light stability of ink. According to the present invention, there is provided a method for manufacturing a reproduction of a painting, comprising: forming an irregularity-reproducing layer, which has irregularities reflecting the irregularities of the painting being an original painting, on a base sheet by use of a slurried mixture containing an organic binder, calcium hydroxide having a volume-based median diameter (d50), as measured by laser diffraction scattering, of 10 μm or less, and a water-insoluble inorganic powder having a volume-based median diameter (d50), as measured by laser diffraction scattering, of 5.0 μm or less; and printing the painting on the irregularity-reproducing layer by inkjet printing.

### TECHNICAL FIELD

This invention relates to a method for manufacturing a reproduction of a painting, which comprises forming on a base sheet an irregularity-reproducing layer having irregularities harmonized with the irregularities of the painting as an original painting; and printing the painting on the irregularity-reproducing layer by inkjet printing.

### BACKGROUND ART

In a painting such as an oil painting, an acrylic painting, or a Japanese-style painting, matiere (“e” between i and r has a grave accent) is present. The term “matiere”, a term in art, represents irregularities and texture on the surface of the painting, arise owing to the material feeling of paint or a thick or thin coat of the paint.

For the oil painting, for example, oil paint is used which comprises a pigment dissolved with a drying oil collected from seeds of a plant such as linseed. Since the oil paint has a high consistency, it can be coated a plurality of times, enabling a technique for forming matiere by handwriting (touch).

The acrylic painting is a painting drawn using paint formed by adding an acrylic resin emulsion to a pigment, and kneading the resulting mixture (i.e., acrylic paint). The acrylic paint is quick-drying as compared with the oil paint, and is thus capable of forming matiere ascribed to a thick coat, like the oil paint. Since it is water-soluble, it also enables a technique similar to the one for transparent watercolors to be employed.

Among techniques for the Japanese-style painting is a method which comprises painting using a natural mineral pigment, such as powdered calcium carbonate, and using a glue as an adhesive to form matiere.

As mentioned above, many of those paintings have a unique color tone, and large/small irregularities, namely, matiere, and are thus able to create special feelings as compared with planar paintings such as watercolor paintings. Hence, the paintings with matiere are also graceful.

In the manufacture of reproductions of paintings such as reproduction paintings, therefore, it is necessary to reproduce the matiere characteristic of the original painting to the maximum extent possible.

Patent Document 1 discloses a reproduction painting having an underlying irregularity layer, an UV ink layer, a hiding layer, an acceptance layer, and a pattern layer formed in this order on a paper base material in order to reproduce fine irregularities characteristic of a natural mineral pigment. Concretely, this document discloses the reproduction painting in which the underlying irregularity layer containing a powder of white limestone and a powder of calcium carbonate has been formed, and the difference in average altitude between protrusions and depressions and the formation density of the protrusions and/or the depressions have been adjusted to predetermined ranges by the underlying irregularity layer. The document also discloses that the hiding layer is formed on the UV ink layer by use of the white limestone powder and the calcium carbonate powder, and that the hiding layer conceals gloss resulting from the UV ink layer and adds a feel like that of a natural mineral pigment.

### PRIOR ART DOCUMENTS

### Patent Documents

Patent Document 1: Japanese Patent No. 5437860

### SUMMARY OF THE INVENTION

### Problems to be Solved by the Invention

With the method of Patent Document 1, fine irregularities characteristic of a Japanese-style painting can be reproduced, since a white limestone powder and calcium carbonate with large particle sizes are used in the underlying irregularity layer and the hiding layer. It has been difficult, however, to manufacture a reproduction painting based on an original painting having matiere with a smooth surface as does an oil painting. The reproduction painting obtained by the method of Patent Document 1, moreover, has been inferior in light stability, and has the drawback that the color of ink fades with the passage of time. Furthermore, the process involved has been complicated, and thus disadvantageous in terms of cost for the manufacture of small lots.

It is an object of the present invention, therefore, to provide a method for manufacturing a reproduction of a painting, which can use different types of paintings as original paintings and reproduce the matiere of the original paintings and which also improves the light stability of ink used.

It is another object of the invention to provide an inkjet reproduction of a painting, which reproduces not only the image of the painting as an original painting, but also the matiere of the original painting and, moreover, excels in the light resistance of the ink.

### Means for Solving the Problems

In an attempt to reproduce the matiere of an original painting in a reproduction of the painting, the present inventors provided the reproduction with a layer reflecting the irregularities of the original painting. In so doing, they conducted numerous experiments to study the composition of such a layer, and the printing properties when inkjet printing is performed on that layer. As a result, they solved the aforementioned problems. That is, the features of the present invention are as follows:

According to the present invention, there is provided a method for manufacturing a reproduction of a painting, comprising: forming an irregularity-reproducing layer, which has irregularities reflecting irregularities of the painting being an original painting, on a base sheet by use of a slurried mixture containing an organic binder, calcium hydroxide having a volume-based median diameter (d50), as measured by laser diffraction scattering, of 10 μm or less, and a water-insoluble inorganic powder having a volume-based median diameter (d50), as measured by laser diffraction scattering, of 5.0 μm or less; and printing the painting on the irregularity-reproducing layer by inkjet printing.

In the method for manufacturing a reproduction of a painting according to the present invention, it is preferred that

(1) the organic binder comprises at least one resin selected from the group consisting of an acrylic resin, a styrene-acrylic resin, a vinyl acetate resin, an ethylene-vinyl acetate resin, a polyvinyl alcohol resin, and a urethane resin;
(2) an auxiliary image is printed on the base sheet by inkjet printing, and then the irregularity-reproducing layer is formed based on the auxiliary image;
(3) the base sheet is a base paper on which a layer containing semisolid plaster has been formed; and
(4) the reproduction of a painting is a reproduction painting.

According to the present invention, there is also provided an inkjet reproduction of a painting, comprising: a base sheet; an irregularity-reproducing layer formed on the base sheet and reflecting irregularities of the painting; and an inkjet-printed image of the painting formed on the irregularity-reproducing layer, wherein the irregularity-reproducing layer contains calcium carbonate, and a water-insoluble inorganic powder different from calcium carbonate and having a volume-based median diameter (d50), as measured by laser diffraction scattering, of 5.0 μm or less.

In the inkjet reproduction of a painting according to the present invention, it is preferred that a gray-scale image representing irregularity information on the painting be formed, as an auxiliary image, on the base sheet, and the irregularity-reproducing layer be formed so as to cover the gray-scale image.

### Effects of the Invention

The method for manufacturing a reproduction of a painting according to the present invention is importantly characterized in that the irregularity-reproducing layer having irregularities reflecting the irregularities of the original painting is formed between the base layer and the inkjet-printed image with the use of the slurried mixture containing calcium hydroxide and the water-insoluble inorganic powder.

Calcium hydroxide (commonly called slaked lime) has the property of reacting with a carbon dioxide gas in air, turning into plaster, namely, calcium carbonate, with the passage of time. In the irregularity-reproducing layer, therefore, part of the calcium hydroxide is carbonated to be converted into plaster (calcium carbonate). As seen here, a mixture in which calcium hydroxide and calcium carbonate formed upon carbonation of calcium hydroxide are both present is designated herein as semisolid plaster. The surface of the irregularity-reproducing layer having the semisolid plaster is porous and hydrophilic. When inkjet printing is done on the irregularity-reproducing layer, therefore, ink (pigment or dye) permeates the irregularity-reproducing layer, and calcium hydroxide remaining in the irregularity-reproducing layer dissolves in water contained in the printing ink and floats up to the surface. Then, the calcium hydroxide floating to the surface and the calcium hydroxide remaining in the irregularity-reproducing layer are carbonated, and completely solidified plaster is formed, with the pigment or dye being taken up into the irregularity-reproducing layer. In the method of the present invention, therefore, the irregularity-reproducing layer also has a function as a printing layer, and it becomes possible to perform inkjet printing directly on the irregularity-reproducing layer. In addition, in the reproduction of a painting manufactured by the present invention, a thin layer of calcium carbonate functions as a protective layer, so that the pigment or dye escapes being deteriorated by ultraviolet radiation or the like, thus improving the light resistance of the reproduction.

In the present invention, moreover, the water-insoluble inorganic powder is also contained in the slurried mixture for formation of the irregularity-reproducing layer. The water-insoluble inorganic powder imparts thixotropic properties to the slurried mixture. If irregularities conformed to the matiere of the original painting are formed using the slurried mixture provided with such properties, solidification of the slurried mixture can be allowed to proceed while maintaining the shape of the irregularities. According to the manufacturing method of the present invention, therefore, the reproduction of a painting maintaining the same irregularities as those of the original painting can be obtained.

Furthermore, with the present invention, the irregularity-reproducing layer can be easily formed by mere coating with the slurried mixture and, besides, the image can be printed on the irregularity-reproducing layer directly by inkjet printing. Thus, the reproduction of a painting can be obtained with ease and at low cost. In addition, the method of the present invention is suitable for the manufacture of a small lot involving, for example, 200 reproductions or less.

### BRIEF DESCRIPTION OF THE DRAWINGS

FIG. 1 is a schematic sectional view showing an example of a reproduction of a painting according to the present invention.

### MODE FOR CARRYING OUT THE INVENTION

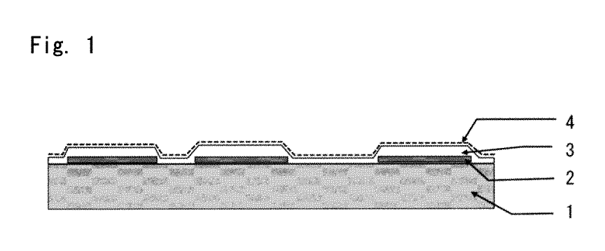

The embodiments of the present invention will now be described by reference to the accompanying drawings. FIG. 1 is a schematic sectional view showing an example of a reproduction of a painting which is obtained by the manufacturing method of the present invention. The reproduction in FIG. 1 is composed of a base sheet 1, an auxiliary image 2, an irregularity-reproducing layer 3, and an inkjet-printed image 4. Referring to FIG. 1, the members constituting the reproduction, and a method for manufacturing the reproduction in the present invention will be described below.

### <Base Sheet>

As the base sheet 1, any material can be used without limitation, if the irregularity-reproducing layer 3 can be formed when the surface of the material is coated with a slurried mixture to be described later. Concretely, wood pulp paper, or resin sheets or films comprising the following resins can be used as the base sheet:
vinyl resins such as polyvinyl alcohol and polyvinyl acetate;
acrylic resins such as poly(meth)acrylate;
polyolefin resins such as polyethylene and polypropylene; and
polyester resins such as polyethylene terephthalate.
   Alternatively, woven fabrics or nonwoven fabrics comprising fiber materials such as glass fiber, vinylon fiber, polypropylene fiber, polyester fiber, polyethylene terephthalate fiber, acrylic fiber, aramid fiber, and carbon fiber can be used as the base sheet. The base sheet may also be a laminated film or sheet composed of two or more of these materials laminated together.

Of the above-mentioned base sheets, the preferred base sheet 1 has flexibility and moderate nerve. Even if folded, the base sheet 1 having such properties minimally forms a crease, and can thus effectively suppress such an inconvenience that cracks are formed in the irregularity-reproducing layer 3 provided on the base sheet 1. Examples of the preferred base sheet 1 generally include pulp paper such as Japan art paper or paper for painting; a synthetic paper prepared by mixing chemical fibers such as glass fibers, polyvinyl acetate fibers, polyester fibers, or vinylon fibers, as binder fibers, with pulp; inorganic paper prepared by mixing calcium carbonate or aluminum hydroxide with pulp; and the printing sheet described in Japanese Patent No. 5039701 in which a printing layer containing semisolid plaster has been formed on abase paper. These base sheets are generally available, have flexibility and bending strength, and enable adherability to the irregularity-reproducing layer 3 to be satisfactory.

The above term, “the printing sheet described in Japanese Patent No. 5039701 in which a printing layer containing semisolid plaster has been formed on a base paper,” concretely refers to a printing sheet in which the printing layer provided on the base paper has calcium hydroxide, and part of this calcium hydroxide has reacted with a carbon dioxide gas in the air to form plaster (calcium carbonate).

The surface of the base sheet 1 may be subjected to corona treatment or the like for improved hydrophilicity. This makes it possible to enhance joining strength between the irregularity-reproducing layer 3 and the base sheet 1.

The thickness of the base sheet 1 is set in an appropriate range according to the type of the original painting or the type of the desired reproduction. Usually, the thickness is set such that the average thickness is 0.015 to 0.5 mm. If the base sheet is too thick, there is a possibility that the base sheet provided with the irregularity-reproducing layer will fail to pass through a printer, when the painting is to be inkjet-printed after formation of the irregularity-reproducing layer. If the base sheet is too thin, the strength of the reproduction to be finally obtained may decrease.

### <Formation of Auxiliary Image>

In the present invention, it is preferred that prior to the formation of the irregularity-reproducing layer 3, the irregularity information of the original painting be printed beforehand on the surface of the base sheet 1 to form the auxiliary image 2. By forming the irregularity-reproducing layer 3 based on the auxiliary image 2, concretely, by coating the slurried mixture so as to cover the auxiliary image 2, it becomes possible to obtain a reproduction of the painting having the matiere of the original painting reproduced with higher accuracy. The irregularity information, for example, refers to the differences between the thickness at the point of reference, which is the thinnest site of the original painting, and the thicknesses at respective positions of the original painting.

A method for printing the base sheet 1 with the irregularity information of the original painting is a publicly known printing method, for example, inkjet printing, laser printer printing, intaglio printing, gravure printing, screen printing, or offset printing. If the number of reproductions to be manufactured is small (e.g., 10 or less), inkjet printing is used preferably.

As the irregularity information of the original painting to be printed, data of a gray-scale image are preferred. The gray-scale image is obtained, for example, by steps indicated in (1) to (3) below with the use of a personal computer:
(1) The original painting is photographed in high resolution to obtain a high-resolution image of the original painting.
(2) Using the resulting high-resolution image, the state of irregularities of the original painting is converted into a pseudo-3D image.
(3) The resulting pseudo-3D image is converted into a gray-scale image.

The gray-scale image preferably has a 16-level gray scale in which the color is blacker at the site of a thicker coat of the paint, and whiter at the site of a thinner coat of the paint. As shown in FIG. 1, if the base sheet 1 is white, the auxiliary image 2 may be formed, with coating with ink being omitted at a white site in the gray-scale image.

The thickness of the auxiliary image 2 is preferably less than 20 μm at the thickest site. If the auxiliary image 2 is too thick, the irregularities of the irregularity-reproducing layer 3 when formed, and the irregularities ascribed to the auxiliary image may be intermingled, making it difficult to reproduce the original painting faithfully.

### <Formation of Irregularity-Reproducing Layer>

In the present invention, the irregularity-reproducing layer 3 is formed on the base sheet 1 (the auxiliary image 2 if it is provided). The following are required of the irregularity-reproducing layer 3: (1) Its surface is smooth and lustrous as in an oil painting. (2) It adheres firmly to the base sheet 1, and no peeling or cracking is caused by a handling operation during a drying step or an inkjet printing step. (3) Upon coating or spraying with ink at the time of forming an inkjet-printed image, no bleeding or mottling occurs.

The irregularity-reproducing layer 3, which fulfills the above requirements, is easily obtained by coating a slurried mixture—containing an organic binder, calcium hydroxide particles having a volume-based median diameter (d50) in a passing portion cumulative distribution, as measured by laser diffraction scattering, (may hereinafter be referred to simply as “d50”) of 10 μm or less, and a water-insoluble inorganic powder having d50 of 5.0 μm or less—so as to reflect the irregularities of the original painting, and then drying the coating moderately.

The slurried mixture for use in the formation of the irregularity-reproducing layer 3 is preferably water-based or alcohol-based. Concretely, a medium (solvent or dispersion medium) in the slurried mixture is exemplified by water, methanol, ethanol, propanol, isopropanol and butanol. These media may be used alone or as a mixture of two or more.

The organic binder incorporated in the slurried mixture is required to satisfy the following: (1) It keeps the slurried mixture at a viscosity facilitating coating. (2) It disperses inorganic powders (calcium hydroxide and water-insoluble inorganic powder) uniformly. (3) It increases adhesion to the base sheet 1 (the auxiliary image 2 if it is provided) after being dried. (4) It enhances the integrity of the inorganic powders. The organic binder fulfilling such requirements can be exemplified by an acrylic resin, a styrene-acrylic resin, a vinyl acetate resin, an ethylene-vinyl acetate resin, a polyvinyl alcohol resin, and a urethane resin. From the viewpoint of hydrophobicity, an acrylic resin, a styrene-acrylic resin, a vinyl acetate resin, an ethylene-vinyl acetate resin, and a urethane resin are used preferably.

The organic binder may be used as such, but may be used after being dissolved in a medium (water or alcohol), or after being dispersed in the medium, like an emulsion.

The content of the organic binder in the solids present in the slurried mixture is preferably 5 to 40% by mass, more preferably 10 to 30% by mass, from the viewpoint of imparting both toughness and ink permeability to the resulting irregularity-reproducing layer to the maximum degree.

The slurried mixture contains calcium hydroxide and the water-insoluble inorganic powder in addition to the above organic binder.

The median diameter (d50) of the calcium hydroxide is 10 μm or less, preferably 5 μm or less. Its lower limit is not particularly limited, but generally, is preferably 0.1 μm or more. Calcium hydroxide having such a particle diameter enables the slurried mixture to be coated smoothly and, as a result, easily provides a smooth surface to the resulting irregularity-reproducing layer 3.

In the present invention, the slurried mixture is coated, and dried to remove (volatilize) the medium (water, alcohol), thereby forming the irregularity-reproducing layer 3. Part of the calcium hydroxide contained in the slurried mixture reacts with a carbon dioxide gas in the air, and gradually turns into plaster (calcium carbonate). That is, the irregularity-reproducing layer 3 has calcium carbonate (plaster) formed upon carbonation of calcium hydroxide, and semisolid plaster containing calcium hydroxide which has not been carbonated. The image is printed on this irregularity-reproducing layer 3 to form the inkjet-printed image 4. When this system is allowed to stand in the air, the remaining calcium hydroxide reacts with a carbon dioxide gas in the air to become plaster (calcium carbonate), further proceeding with solidification. At this time, a part of a coloring material contained in the ink is taken up into the resulting plaster (calcium carbonate). As a result, the effect of suppressing the deterioration of the coloring material due to ultraviolet radiation or the like is exhibited, so that the light resistance of the resulting reproduction of the painting is improved. When the resulting irregularity-reproducing layer 3 is allowed to stand in the atmosphere after printing of the image, as noted here, calcium hydroxide remaining in the irregularity-reproducing layer 3 is carbonated and, finally, the irregularity-reproducing layer 3 is completely solidified.

The calcium hydroxide content in the solids present in the slurried mixture is appropriately determined so that the amount of calcium hydroxide in the irregularity-reproducing layer 3 falls within the numerical range to be described later. Usually, it is preferably 10 to 70% by mass, and particularly preferably 15 to 60% by mass.

The slurried mixture also contains the water-insoluble inorganic powder. The water-insoluble inorganic powder refers to an inorganic powder having solubility of 0.1 g or less in 100 g of water at 25° C. If such a water-insoluble inorganic powder is used, the irregularity-reproducing layer 3 does not swell or dissolve with water contained in a water-based ink when a picture is drawn using the ink. Thus, the shape of the irregularity-reproducing layer can be held firmly. Examples of the water-insoluble inorganic powder are silicon dioxide, aluminum oxide, calcium carbonate, and calcium sulfate. From the viewpoint of obtaining a sharp printed image when formed, because of high whiteness, silicon dioxide, aluminum oxide or calcium sulfate is preferably used. From the aspect of cost, aluminum oxide is used particularly preferably. One of the above-mentioned materials is used singly, or two or more of them are used in combination, as the water-insoluble inorganic powder.

The particle size of the water-insoluble inorganic powder needs to be a volume-based median diameter (d50), as measured by laser diffraction scattering, of 5.0 μm or less, preferably 2.0 μm or less. The incorporation of the water-insoluble inorganic powder with such a particle size into the slurried mixture imparts thixotropic properties (the properties of decreasing in viscosity upon agitation or the like, turning into a sol, and increasing in viscosity when allowed to stand, becoming a gel) to the slurried mixture, thereby facilitating the formation of the irregularity-reproducing layer 3. With the high thixotropic properties of the slurred mixture, immediately after coating with the slurried mixture, the slurried mixture does not flow from convex regions to concave regions. The coating can be dried, with irregularities immediately after application of the coating being maintained, and the irregularity-reproducing layer 3 in conformity with the original painting can be formed.

The amount of the water-insoluble inorganic powder in the solids present in the slurried mixture is preferably 10 to 60% by mass, and more preferably 20 to 50% by mass. If the amount of the water-insoluble inorganic powder is too small, the thixotropic properties of the slurried mixture may fail to be exhibited sufficiently. If the amount of the water-insoluble inorganic powder is too large, the toughness of the resulting irregularity-reproducing layer will be low, and the adhesion to the base sheet (the auxiliary image if it is formed) will decline. As a result, there will be a strong tendency to cause an inconvenience such that the irregularity-reproducing layer peels off partly, or is missing, during handling in the printing step or the like.

In the slurried mixture, various additives for adjusting the physical properties, such as a surfactant and a polymeric dispersant, may be incorporated, aside from the above-mentioned organic binder, inorganic powder, and medium. These additives are added in order to improve the stability of the slurried mixture or to improve the printing properties of the irregularity-reproducing layer 3 functioning also as a printing layer.

The surfactant is used to disperse the organic binder, inorganic powder, etc., which are incorporated in the slurried mixture, in the medium (water, alcohol) stably and uniformly.

The surfactant is added particularly when the slurried mixture is water-based. In this case, the surfactant may be one which is soluble in water, and any of an ionic surfactant, an ampholytic surfactant, and a nonionic surfactant can be used. Each of the surfactants can be used alone, or two or more of them can be used in combination. The amount of the surfactant blended is determined, as appropriate, so that a satisfactory dispersion can be ensured.

Typical examples of the ionic surfactant are anionic surfactants and cationic surfactants listed below.

Anionic Surfactants:
Sodium dodecylbenzenesulfonate, sodium dialkyl sulfosuccinate, sodium lauryl sulfate, sodium polyoxyethylene alkyl ether sulfate, sodium polyoxyethylene alkyl phenyl ether sulfate, ammonium polyoxyethylene alkyl ether sulfate, ammonium polyoxyethylene alkyl phenyl ether sulfate, polyoxyethylene alkyl ether phosphoric ester, and polyoxyethylene alkyl phenyl ether phosphoric ester.

Cationic Surfactants:
Lauryltrimethylammonium chloride, and trimethyloctadecylammonium chloride.

Typical examples of the ampholytic surfactant are:
Lauryl betaine and lauryl dimethylamine oxide.

Typical examples of the nonionic surfactant are as follows:
Polyoxyethylene alkyl ether, polyoxyethylene alkylallyl ether, polyoxyethylene-oxypropylene block polymer, polyethylene glycol fatty acid ester, and polyoxyethylene sorbitan fatty acid ester.

The polymeric dispersant is preferably added when the slurried mixture is water-based. The polymeric dispersant is not particularly limited, but may be any publicly known one, if it has a high molecular weight, is hydrophilic, and can disperse calcium hydroxide or the water-insoluble inorganic powder. Typical examples of the polymeric dispersant are lignin sulfonic acid salt, melamine sulfonic acid salt, naphthalenesulfonic acid salt, and polycarboxylic acid salt. Of them, the polycarboxylic acid salt is used preferably.

The polycarboxylic acid salt can be exemplified by the following:
salts of styrene-maleic anhydride copolymer or its partial ester (see JP-A-1-92212),
salts of allyl ether-maleic anhydride copolymer or its derivative (see JP-A-63-285140),
salts of (meth)acrylic acid-(meth)acrylic ester copolymer or its derivative (see JP-A-58-74552, JP-A-1-226757),
salts of isobutylene-maleic anhydride copolymer or its derivative (see JP-A-60-103062), and
products formed by grafting of alkylene glycol chains to the side chains of these polycarboxylic acid salts (see JP-A-2007-332027).
   The salts can be exemplified by alkali metal salts, alkaline earth metal salts, lower amine salts, and lower alkanolamine salts. In the present invention, any of the polycarboxylic acids having an alkylene glycol chain is used preferably. The mass average molecular weight of the polycarboxylic acid salt is preferably in the range of 1,000 to 100,000.

The polymeric dispersant is preferably used in an amount of 0.5 to 10% by mass based on the inorganic powder. If the amount of the polymeric dispersant used is too small, the dispersing effect may fail to be sufficiently exerted. If the polymeric dispersant is used in a larger amount than required, on the other hand, the viscosity of an aqueous slurry of slaked lime (calcium hydroxide) will change greatly over time, posing the possibility of the resulting slurried mixture becoming unstable.

The slurried mixture is prepared by charging the above-mentioned organic binder, calcium hydroxide, water-insoluble inorganic powder, and the additives to be used if desired, into the medium, and mixing them with a proper amount of the medium. The respective materials and the medium may be charged all at once. Alternatively, after the organic binder and the medium are charged and stirred, the remaining materials may be charged. The mixing may be performed in accordance with a publicly known method.

The viscosity of the slurried mixture can be adjusted by the amount of the medium added. The viscosity of the slurried mixture is preferably adjusted to 5 to 100 Pa·S in order to form the irregularity-reproducing layer.

The so obtained slurried mixture is coated on the base sheet 1 (the auxiliary image 2 if is provided), and then dried to form the irregularity-reproducing layer 3.

The coating, concretely, may be performed using any of various printing means such as screen printing and gravure printing, or using a painting implement such as a writing brush, a brush, or a spatula, thereby forming irregularities corresponding to the irregularities of the original painting. It is preferred, however, that the slurried mixture be coated using a painting implement, such as a writing brush, a brush, or a spatula, so as to form irregularities corresponding to the irregularities of the original painting. The slurried mixture may be coated all over the base sheet 1, but depending on the mode of the matiere of the original painting, the slurried mixture may be coated partly on the base sheet 1. In detail, among Japanese-style paintings, for example, are works in which most of the scenes are painted two-dimensionally, and a paint and glue are coated thickly in only some parts. In case the original painting partly has irregularities, it suffices to coat the slurried mixture only partly. In this case, the irregularity-reproducing layer 3 is present partly on the base sheet 1 (the auxiliary image 2 if it is formed).

Drying may be performed by a publicly known method such as natural drying or heat drying. From the viewpoint of performing drying in a short time, however, heat drying is preferred and, from the aspect that deformation or the like of the base sheet does not occur, heat drying at 40 to 120 degrees is more preferred. It is recommendable to carry out drying such that the content of the medium (water, alcohol) in the irregularity-reproducing layer 3 is of the order of 5% or less.

The thickness of the irregularity-reproducing layer 3 is preferably 50 to 500 μm at the thickest site. If the thickness of the irregularity-reproducing layer 3 is too small, the irregularities cannot be sensed visually, and it is likely that characteristics, such as gracefulness, which the original painting has because of its matiere cannot be imparted to the resulting reproduction. If the thickness is too large, transportability during inkjet printing to be described later may be impaired. In addition, the printer head for an ink jet and the irregularity-reproducing layer 3 may contact, and the irregularity-reproducing layer 3 may fall off. The thickness of the irregularity-reproducing layer 3 can be adjusted by the amount of the slurried mixture coated.

The solids content of the polymer in the irregularity-reproducing layer 3 is preferably 5 to 40% by mass, particularly preferably 10 to 30% by mass, in a stage before inkjet printing. In the irregularity-reproducing layer 3 obtained by coating and drying the slurried mixture, the medium (water, alcohol) in the organic binder has evaporated, but the polymeric component remains. The remaining polymeric component has the effect of increasing the toughness of the irregularity-reproducing layer 3 and enhancing its adhesion to the base sheet 1 (the auxiliary image 2 if it is provided). If the solids content of the polymer (i.e., polymer itself) is present excessively in the irregularity-reproducing layer 3, on the other hand, the permeability of the printed image (printing ink) to the irregularity-reproducing layer 3 may be decreased. Thus, the irregularity-reproducing layer 3 with the amount of the polymer lying within the above-mentioned range is excellent in the balance between toughness and permeability.

The irregularity-reproducing layer 3 may be in a semisolid state before being solidified upon complete carbonation of calcium hydroxide. Concretely, the amount of calcium hydroxide in the irregularity-reproducing layer 3 is preferably 10 to 70% by mass, further preferably 15 to 55% by mass, immediately before printing. If the content of calcium hydroxide is lower than the above range, the light resistance of the resulting image tends to decline, causing color fading with ease. That is, when printing is performed, the amount of calcium hydroxide dissolving in the printing ink and migrating to the surface decreases. As a result, the effect of protecting the printed image lowers, and a reduction in the effect of suppressing the deterioration of the printed image due to ultraviolet radiation occurs. If the amount of calcium hydroxide is too large, the toughness of the irregularity-reproducing layer 3 declines, and damage to the irregularity-reproducing layer 3 is apt to occur during the printing step.

The adjustment of the amount of calcium hydroxide in the irregularity-reproducing layer 3 can be made by adjusting the proportion of the mass of calcium hydroxide for use in the formation of the irregularity-reproducing layer 3, the carbonation rate of calcium hydroxide (the proportion of the mass of the resulting calcium carbonate to the mass of calcium hydroxide used in the preparation of the aforementioned slurry), or the proportion of the organic binder or the water-insoluble inorganic powder or the like.

When the method of adjusting the carbonation rate of calcium hydroxide for use in the formation of the irregularity-reproducing layer 3 is used among the above-mentioned methods for adjustment, the upper limit of the carbonation rate is desirably set at 60%, particularly 40%. If carbonation proceeds excessively, the surface of the irregularity-reproducing layer tends to be densified, and the permeability of the printing ink tends to lower. The degree of densification of the surface by carbonation can be determined, for example, by the frictional resistance of the surface of the irregularity-reproducing layer.

The amount of calcium hydroxide in the irregularity-reproducing layer 3 can be confirmed by differential thermal analysis or the ignition loss method.

The carbonation reaction of calcium hydroxide proceeds upon contact with a carbon dioxide gas. As long as the system after formation of the irregularity-reproducing layer 3 is stored in a sealed state in an air-impermeable bag, container or the like to avoid contact with a carbon dioxide gas in the air, a predetermined carbonation rate can be maintained to hold the amount of calcium hydroxide in the irregularity-reproducing layer 3 within a certain range.

The amount of the water-insoluble inorganic powder in the irregularity-reproducing layer 3 is determined, as appropriate, by the amount of the water-insoluble inorganic powder incorporated in the slurred mixture, but usually, is preferably 10 to 60% by mass in a stage prior to inkjet printing.

### <Formation of Inkjet-Printed Image>

After formation of the irregularity-reproducing layer 3, the image of the original painting is printed by inkjet printing to form the inkjet-printed image 4. To print the image of the original painting, the use of a con-contact inkjet printer is preferred. In the present invention, conditions, such as the composition of the irregularity-reproducing layer 3, are adjusted so that the irregularity-reproducing layer 3 also functions as a printing layer for inkjet printing. When the image is printed on the irregularity-reproducing layer 3 with such a nature, therefore, the inkjet-printed image 4 faithful to the original painting, free from ink bleeding or color shading, smooth on the surface, and lustrous is obtained.

### <Inkjet Reproduction of Painting>

After the inkjet-printed image is formed and allowed to stand (usually for 1 to 30 days), calcium hydroxide remaining in the surface and interior of the irregularity-reproducing layer 3 is completely converted into plaster (calcium carbonate), whereby there is obtained an inkjet reproduction of the painting (may hereinafter be referred to as the reproduction of the present invention) reproducing the matiere of the original painting, such as irregularities and texture, faithfully.

The reproduction of the present invention has the base sheet, the irregularity-reproducing layer, and the inkjet-printed image in this order. Furthermore, if a gray-scale image, for example, is formed as the auxiliary image at the time of manufacturing, the gray-scale image is also provided between the base sheet and the irregularity-reproducing layer.

The irregularity-reproducing layer in the reproduction of the present invention has irregularities reflecting the irregularities of the painting as the original painting. The irregularity-reproducing layer in the reproduction of the present invention contains calcium carbonate and the water-insoluble inorganic powder with d50 of 5.0 μm or less. That is, as stated above, while the system is being left to stand after the formation of the inkjet-printed image, all the calcium hydroxide present in the surface and interior of the irregularity-reproducing layer is carbonated to become plaster (calcium carbonate). Thus, the irregularity-reproducing layer in the reproduction of the present invention contains calcium carbonate formed by carbonation of calcium hydroxide. Moreover, the irregularity-reproducing layer in the reproduction of the present invention has the water-insoluble inorganic powder remaining as such which has been incorporated in the slurried mixture in order to impart thixotropic properties.

The reproduction of the present invention having such features includes not only a reproduction painting, but also a postcard, a message card, a poster, and a pamphlet. From the viewpoint of exhibiting the effects of the present invention maximally, the reproduction painting is preferred. The reproduction painting includes a reproduction of the original painting on a reduced or enlarged scale, as well as a reproduction of the same size as the original painting.

### Examples

The excellent effects of the present invention will be explained by the following experimental examples. Testing methods and test materials used in the experimental examples will be shown below. In the Examples, the term “d50” refers to a volume-based median diameter as measured by laser diffraction scattering.

### (1) Evaluation of Texture (Irregularities) and Gloss Feeling (Luster) of Reproduction Painting

(a) A reproduction painting prepared in each of the experimental examples was compared with the original painting (oil painting) visually, and the texture (irregularities) was evaluated under the following criteria:
Good: Reproduces the same texture as the original painting faithfully.
Not good: Reproduces the same texture as the original painting slightly.
Bad: Does not reproduce the same texture as the original painting at all.
   (b) The reproduction painting prepared in each of the experimental examples was compared with the original painting (oil painting) visually, and the gloss feeling (luster) was evaluated under the following criteria:
Good: Reproduces the same gloss feeling as the original painting faithfully.
Not good: Reproduces the same gloss feeling as the original painting slightly.
Bad: Does not reproduce the same gloss feeling as the original painting at all.

### (2) Evaluation of Yellow Ink Weatherability

The slurried mixture produced under the conditions shown in each experimental example was coated on the base sheet (300 mm×300 mm) used in each experimental example by means of a roller brush (made of nylon bristles) so that a coating thickness after drying would be 100 to 150 μm, whereby a specimen having the irregularity-reproducing layer was prepared. Then, a yellow color (density: 100% yellow) was printed on the entire surface by an inkjet printer (PX-5600, manufactured by Epson Corporate, using aqueous ink having a pigment dispersed therein). After drying for 1 hour, the printed sheet was cut into two pieces measuring 100 mm×100 mm. One of the pieces (ultraviolet irradiation specimen) was irradiated with ultraviolet rays with an intensity of 500 μW/cm² for 4 months by an ultraviolet irradiation fluorescent lamp (“Neolumisuper”, manufactured by Mitsubishi Electric Corporation, model: FL30SBL-360), whereas the other piece (dark storage specimen) was stored in a dark place.

The ultraviolet irradiation specimen irradiated with ultraviolet rays, and the dark storage specimen stored in the dark place were taken out. Using a spectrophotometric color difference meter (a handy type simplified spectrophotometric color difference meter, manufactured by NIPPON DENSHOKU INDUSTRIES CO., LTD., model: NF333), the color difference (ΔE), in the L*a*b* color system, of the yellow color between the ultraviolet irradiation specimen and the dark storage specimen was found in compliance with JIS Z 8730. The greater a change in color, the larger the color difference (ΔE) is.

### (3) Evaluation of Bleeding of Printed Image

The slurried mixture produced under the conditions shown in each experimental example was coated on the base sheet (300 mm×300 mm) used in each experimental example by means of a roller brush (made of nylon bristles) so that the thickness of the irregularity-reproducing layer after drying would be 100 to 150 μm, whereby a test piece having the irregularity-reproducing layer was prepared. Then, each of four colors, magenta (color density: 100%), cyan (color density: 100%), yellow (color density: 100%) and matte black (color density: 100%), was separately printed in a square with a side length of 10 mm on the surface of the recording paper by an inkjet printer (PX-5600, manufactured by Epson Corporate, using aqueous inks having pigments dispersed therein), and the system was allowed to stand for 24 hours indoors to obtain a specimen.

The resulting specimen was read into a personal computer with the use of a digital microscope (VHX-5000, manufactured by Keyence Corporation) to acquire a digital image. Using image processing software, the number of pixels in each color was measured, and the total value of the four colors was calculated. For comparison, the number of pixels in each color upon printing in the same manner on an inkjet paper (genuine product by Epson) was measured, and the total value of the four colors was calculated. Based on the total pixel value of each of the specimen and the inkjet paper, the rate of bleeding (or spread rate; SR) was calculated from the equation indicated below. If the bleeding of the specimen is comparable to the bleeding of the inkjet paper, SR=1. If the bleeding of the specimen is greater than the bleeding of the inkjet paper, the bleeding rate (SR) increases.

SR=P1/P0
SR: Bleeding rate
P1: Total number of pixels in the four colors printed on the specimen
P0: Total number of pixels in the four colors printed on the inkjet paper

### (4) Measurement of Carbonation Rate

Calcium hydroxide and calcium carbonate in the irregularity-reproducing layer were quantitatively measured by the ignition loss method, and the rate of the change from calcium hydroxide into calcium carbonate was calculated as the rate of carbonation.

### <Materials Used in Each Experimental Example>

Base Sheet:
Base sheet A: Inkjet base paper (FK Slat R-IJ, manufactured by Fujikyowa Paper Mfg. Co., Ltd., thickness: 0.17 mm, weight per unit area: 160 g/m²)
Base sheet B: Inkjet paper having a semisolid plaster-containing layer on one surface of the base sheet A (Fresco Giclee, manufactured by Tokuyama Corporation, thickness: 0.40 mm)

Calcium Hydroxide:
Calcium hydroxide A: High-purity slaked lime classified product (Ube Material Industries, Ltd., d50: 2.0 μm)
Calcium hydroxide B: JIS special grade slaked lime classified product (Ube Material Industries, Ltd., d50: 29.3 μm)

Water-Insoluble Inorganic Powder:
Water-insoluble inorganic powder A: Aluminum oxide (alumina monohydrate) (Boehmite C06, manufactured by Taimei Chemicals Co., Ltd., d50: 0.7 μm)
Water-insoluble inorganic powder B: Silicon dioxide {Excelica, manufactured by Tokuyama Corporation (classified product), d50: 1.5 μm}
Water-insoluble inorganic powder C: Calcium carbonate (WHITON SB, manufactured by SHIRAISHI CALCIUM KAISHA, LTD., d50: 2.0 μm)
Water-insoluble inorganic powder D: Calcium sulfate dihydrate {manufactured by Wako Pure Chemical Industries, Ltd. (crushed classified product), d50: 2.6 μm}
Water-insoluble inorganic powder E: Aluminum oxide (alumina monohydrate, manufactured by Wako Pure Chemical Industries, Ltd., d50: 25 μm)

Organic Binder:
Organic binder A: Aqueous acrylic resin emulsion (Polytron, manufactured by Asahi Kasei Corporation, solids concentration: 40% by mass)
Organic binder B: Aqueous vinyl acetate emulsion (Vinyblan, manufactured by Nissin Chemical Industry Co., Ltd., solids concentration: 44% by mass)

Dispersant:
Dispersant A: Polycarboxylic acid copolymer (CHUPOL SSP, manufactured by TAKEMOTO OIL & FAT CO., LTD., solids concentration: 40% by mass)

### Experimental Example 1

The reproduction painting shown in FIG. 1 was produced in accordance with the following method:

### (Formation of Auxiliary Image 2)

A gray-scale image representing irregularity information on an original painting (oil painting) created beforehand was printed on one surface of the base sheet A (pulp paper), which was cut to the size A3, by an inkjet printer. The printed sheet was dried for 5 hours at room temperature to obtain the base sheet A having an auxiliary image 2. The thickness of the auxiliary image 2 on this occasion was 3 microns or less.

### (Preparation of Slurried Mixture)

150 Parts by mass of the organic binder A (60 parts by mass as the amount of the solids), 150 parts by mass of the calcium hydroxide A, 150 parts by mass of the water-insoluble inorganic powder A (aluminum oxide, d50: 0.7 μm), and 5 parts by mass of the dispersant A were weighed, and kneaded for 10 minutes by a Hobart mixture with the addition of water to obtain a slurried mixture having a viscosity of 64 Pa·s. The composition of this slurried mixture is shown in Table 1.

### [Formation of Irregularity-Reproducing Layer 3]

The resulting slurried mixture was coated on the base sheet A having the auxiliary image 2 by use of a commercially available No. 4 writing hard brush in accordance with the irregularity information of the auxiliary image 2, followed by drying the coating, to form an irregularity-reproducing layer 3. The maximum height of the irregularity-reproducing layer 3 was 240 μm. The composition of the resulting irregularity-reproducing layer 3 was measured by ICP emission spectroscopic analysis and the ignition loss method (measurement of carbonation). The results of the measurements are shown in Table 2.

### (Formation of Inkjet-Printed Image 4)

Then, the image of the original painting was inkjet-printed on the base sheet A having the resulting irregularity-reproducing layer 3 with the use of an inkjet printer (PX-5600, manufactured by Epson Corporate, using aqueous inks having pigments dispersed therein), whereby an inkjet-printed image 4 was formed. After drying for 24 hours indoors, a reproduction painting having irregularities conformed to the irregularities of the original painting (oil painting) was obtained.

### (Evaluation of Reproduction Painting)

Evaluations were made in accordance with the aforementioned methods of evaluating the texture (irregularities) and gloss feeling (luster) of the reproduction painting. The results are shown in Table 3.

### (Evaluation of Irregularity-Reproducing Layer 3)

Evaluations were made in accordance with the aforementioned methods of evaluating the bleeding and yellow ink weatherability of the printed image. The results are shown in Table 3.

### Experimental Example 2

A reproduction painting was produced by performing the same procedures as in Experimental Example 1, except that the base sheet A used in Experimental Example 1 was replaced by the base sheet B, and the organic binder A was replaced by the organic binder B. The reproduction painting produced was subjected to the evaluation of the reproduction painting and the evaluation of the irregularity-reproducing layer 3. The results are shown in Table 3.

### Experimental Examples 3 to 8

Reproduction paintings were produced by performing the same procedures as in Experimental Example 2, except that the slurried mixtures were prepared in accordance with the compositions in Table 1. The reproduction paintings produced were subjected to the evaluation of the reproduction painting and the evaluation of the irregularity-reproducing layer 3. The results are shown in Table 3.

### Experimental Example 9

A reproduction painting was produced by performing the same procedures as in Experimental Example 1, except that the calcium hydroxide A was replaced by the calcium hydroxide B. The reproduction painting produced was subjected to the evaluation of the reproduction painting and the evaluation of the irregularity-reproducing layer 3. The results are shown in Table 3.

### Experimental Example 10

A reproduction painting was produced by performing the same procedures as in Experimental Example 1, except that the water-insoluble inorganic powder A was replaced by the water-insoluble inorganic powder E. The reproduction painting produced was subjected to the evaluation of the reproduction painting and the evaluation of the irregularity-reproducing layer 3. The results are shown in Table 3.

### Experimental Example 11

A reproduction painting was produced by performing the same procedures as in Experimental Example 1, except that the calcium hydroxide A was replaced by the water-insoluble inorganic powder E. The reproduction painting produced was subjected to the evaluation of the reproduction painting and the evaluation of the irregularity-reproducing layer 3. The results are shown in Table 3.

TABLE 1

| | | Composition of slurried mixture (parts by mass) | | | | | | | | | |
|---|---|---|---|---|---|---|---|---|---|---|---|
| | | | | inorganic powder | | | | | | | Viscosity |
| | | organic | | calcium | inorganic fine | | | | | | of slurried |
| | Base | binder | | hydroxide | powder | | | | dispersant | | mixture |
| | sheet | A | B | A | A | B | C | D | A | water | Pa · s |
| Exp. Ex. 1 | A | 150 | — | 150 | 150 | — | — | — | 5 | 100 | 64 |
| Exp. Ex. 2 | B | — | 150 | 150 | 150 | — | — | — | 5 | 110 | 29 |
| Exp. Ex. 3 | B | 200 | — | 100 | 150 | — | — | — | 5 | 90 | 52 |
| Exp. Ex. 4 | B | 150 | — | 150 | 60 | — | — | — | 5 | 100 | 59 |
| Exp. Ex. 5 | B | 150 | — | 120 | 150 | — | — | — | 5 | 95 | 72 |
| Exp. Ex. 6 | B | 150 | — | 120 | — | 150 | — | — | 5 | 95 | 67 |
| Exp. Ex. 7 | B | 150 | — | 120 | — | — | 150 | — | 5 | 95 | 69 |
| Exp. Ex. 8 | B | 150 | — | 120 | — | — | — | 150 | 5 | 100 | 70 |

Exp. Ex.: Experimental Example

TABLE 2

| | Composition of solids of irregularity-reproducing layer (% by mass) | | | | | | | | | |
|---|---|---|---|---|---|---|---|---|---|---|
| | | | inorganic powder | | | | | | carbonated calcium | |
| | organic | | | water-insoluble | | | | | hydroxide | |
| | binder | | Ca(OH)₂ | inorganic fine powder | | | | dispersant | % by | (carbonation |
| | A | B | A | A | B | C | D | A | mass | rate) |
| Exp. Ex. 1 | 16.4 | — | 34.9 | 41.1 | — | — | — | 1.4 | 6.2 | (15%) |
| Exp. Ex. 2 | — | 16.4 | 34.5 | 41.1 | — | — | — | 1.4 | 6.6 | (16%) |
| Exp. Ex. 3 | 23.9 | — | 23.6 | 44.8 | — | — | — | 1.5 | 6.3 | (21%) |
| Exp. Ex. 4 | 21.8 | — | 48.0 | 21.8 | — | — | — | 1.8 | 6.5 | (12%) |
| Exp. Ex. 5 | 17.9 | — | 30.8 | 44.8 | — | — | — | 1.5 | 5.0 | (14%) |
| Exp. Ex. 6 | 17.9 | — | 30.8 | — | 44.8 | — | — | 1.5 | 5.0 | (14%) |
| Exp. Ex. 7 | 17.9 | — | 30.1 | — | — | 44.8 | — | 1.5 | 5.7 | (16%) |
| Exp. Ex. 8 | 17.9 | — | 29.7 | — | — | — | 44.8 | 1.5 | 6.1 | (17%) |

Exp. Ex.: Experimental Example

TABLE 3

| | *1 | *2 | *3 | *4 |
|---|---|---|---|---|
| Exp. Ex. 1 | good | good | 1.06 | 3.2 |
| Exp. Ex. 2 | good | good | 1.06 | 3.6 |
| Exp. Ex. 3 | good | good | 0.98 | 4.3 |
| Exp. Ex. 4 | good | good | 0.98 | 2.9 |
| Exp. Ex. 5 | good | good | 1.08 | 4.1 |
| Exp. Ex. 6 | good | good | 1.02 | 3.1 |
| Exp. Ex. 7 | good | good | 1.04 | 3.5 |
| Exp. Ex. 8 | good | good | 1.06 | 3.7 |
| Exp. Ex. 9 | not good | bad | 1.21 | 4.9 |
| Exp. Ex. 10 | bad | bad | 1.33 | 6.5 |
| Exp. Ex. 11 | not good | not good | 1.29 | 10.8 |

*1: Texture (irregularities)
*2: Gloss feeling (luster)
*3: Bleeding rate (RS)
*4: Evaluation of weatherability (ΔE)
Exp. Ex.: Experimental Example

### EXPLANATIONS OF LETTERS OR NUMERALS

1: Base sheet
2: Auxiliary image
3: Irregularity-reproducing layer
4: Inkjet-printed image

1-7. (canceled)

8. A method for manufacturing a reproduction of a painting, comprising:
printing an auxiliary image on a base sheet by inkjet printing;
then forming an irregularity-reproducing layer, which has irregularities reflecting irregularities of the painting being an original painting, on the base sheet based on the auxiliary image by use of a slurried mixture containing an organic binder, calcium hydroxide having a volume-based median diameter (d50), as measured by laser diffraction scattering, of 10 μm or less, and a water-insoluble inorganic powder having a volume-based median diameter (d50), as measured by laser diffraction scattering, of 5.0 μm or less; and
printing the painting on the irregularity-reproducing layer by inkjet printing.

9. The method for manufacturing according to claim 8, wherein
the organic binder comprises at least one resin selected from the group consisting of an acrylic resin, a styrene-acrylic resin, a vinyl acetate resin, an ethylene-vinyl acetate resin, a polyvinyl alcohol resin, and a urethane resin.

10. The method for manufacturing according to claim 8, wherein
the base sheet is a base paper on which a layer containing semisolid plaster has been formed.

11. The method for manufacturing according to claim 8, wherein
the reproduction of a painting is a reproduction painting.

12. An inkjet reproduction of a painting, comprising:
a base sheet;
an irregularity-reproducing layer formed on the base sheet and reflecting irregularities of the painting; and
an inkjet-printed image of the painting formed on the irregularity-reproducing layer, wherein
the irregularity-reproducing layer contains calcium carbonate, and a water-insoluble inorganic powder different from calcium carbonate and having a volume-based median diameter (d50), as measured by laser diffraction scattering, of 5.0 μm or less,
a gray-scale image representing the irregularities of the painting is formed as an auxiliary image on the base sheet, and
the irregularity-reproducing layer is formed so as to cover the gray-scale image.
